(19) United States
(12) Patent Application Publication
(10) Pub. No.: US 2017/0158315 A1
(43) Pub. Date: Jun. 8, 2017

(54) SYSTEM AND METHOD FOR SPRING ASSISTED LANDING GEAR OPERATION

(71) Applicant: Goodrich Corporation, Charlotte, NC (US)

(72) Inventor: Andrew Joseph Slanker, Fairborn, OH (US)

(73) Assignee: Goodrich Corporation, Charlotte, NC (US)

(21) Appl. No.: 15/436,522

(22) Filed: Feb. 17, 2017

Related U.S. Application Data
(63) Continuation of application No. 13/875,972, filed on May 2, 2013.

(51) Int. Cl. B64C 25/20; B64C 25/12; B64C 25/26

(52) U.S. Cl. CPC B64C 25/20; B64C 25/26; B64C 25/12

(57) ABSTRACT

A landing gear actuation system comprising a motive force system, such as an actuator and/or a piston to move the landing gear from a first position to a second position is disclosed herein. The landing gear actuation system may also comprise a spring system configured to counterbalance the weight of the landing gear and/or assist the motive force system in moving the landing gear from a firs position to a second position. The landing gear actuation system may further comprise a camming mechanism to distribute the direction and/or location of the force applied to the landing gear.

### CROSS-REFERENCE TO RELATED APPLICATIONS

This U.S. Continuation Patent Application claims priority to U.S. patent application Ser. No. 13/875,972, entitled “SYSTEM AND METHOD FOR SPRING ASSISTED LANDING GEAROPERATION,” and filed on May 2, 2013, all of which is incorporated herein by reference in its entirety.

### FIELD

The present disclosure is related to a landing gear assembly for use with, for example, aircraft.

### BACKGROUND

Aircraft landing gear is typically heavy (e.g. between about 2 and 6 tons (about 1814 and 5443 kilograms)). Because of the high forces involved in raising and lowering the landing gear, robust hydraulic systems have conventionally been used to lift such landing gear systems. Hydraulic systems used are generally large and heavy because of many factors including, but not limited to, the size and weight of the actuator needed to lift the landing gear to a stowed position.

### SUMMARY

The present disclosure relates to a landing gear actuation system that addresses, among other things, the aforementioned deficiencies in prior systems. For instance, a landing gear actuation system in accordance with various embodiments may comprise a motive force system, such as an actuator and/or a piston to move the landing gear from a first position to a second position. The landing gear actuation system may also comprise a spring system configured to counterbalance the weight of the landing gear and/or assist the motive force system in moving the landing gear from a first position to a second position. The landing gear actuation system may further comprise a camming mechanism to distribute the direction and/or location of the various forces applied to the landing gear.

According to various embodiments, an aircraft landing gear deployment system may comprise a motive force system configured to move a landing gear assembly from a first position to a second position and a spring system configured to counterbalance the weight of the landing gear assembly.

According to various embodiments, an aircraft landing gear deployment system may comprise a motive force system configured to move a landing gear assembly from a deployed position to a stowed position, and a spring system configured to reduce an amount of force for moving the landing gear assembly from the deployed position to the stowed position. The spring system may operate in concert with the motive force system.

A method of deploying landing gear is disclosed. The method of deploying landing gear may comprise receiving a first signal from a controller to initiate landing gear retraction. The method may further comprise initiating operation of a motive force system configured to move a landing gear assembly from a first position to a second position.

The method may also comprise unlocking or otherwise initiating operation of a spring system configured to counterbalance the weight of the landing gear assembly. The method may also comprise locking the landing gear assembly in a deployed position.

### BRIEF DESCRIPTION OF THE DRAWINGS

Various embodiments are particularly pointed out and distinctly claimed in the concluding portion of the specification. Below is a summary of the drawing figures, wherein like numerals denote like elements and wherein:

FIG. 1 illustrates an exemplary spring system and a motive force system coupled to a landing gear assembly, in accordance with various embodiments;

FIG. 2A illustrates an exemplary torsion spring of a spring system coupled to a landing gear assembly in a deployed orientation in accordance with various embodiments;

FIG. 2B illustrates an exemplary torsion spring of a spring system coupled to a landing gear assembly in a stowed orientation in accordance with various embodiments;

FIGS. 3A and 3B illustrate various views of an exemplary torsion spring coupled to a transfer mechanism, in accordance with various embodiments;

FIG. 4A illustrates an exemplary leaf spring of a spring system coupled to a landing gear assembly, in accordance with various embodiments;

FIG. 4B illustrates an exemplary leaf spring of a spring system coupled to a plurality of landing gear assemblies, in accordance with various embodiments;

FIG. 5A illustrates a front view of an exemplary camming mechanism coupled to a nose, rear retracting landing gear as viewed from the front of the aircraft configured for use with the spring system, in accordance with various embodiments;

FIG. 5B illustrates a profile view of the exemplary camming mechanism of FIG. 5A as viewed from a location perpendicular to the axis of the fuselage in accordance with various embodiments;

FIG. 5C illustrates a front view of an exemplary camming mechanism configured for use with the motive force system coupled to a nose, rear retracting landing gear as viewed from the front of the aircraft in accordance with various embodiments;

FIG. 5D illustrates a profile view of the exemplary camming mechanism of FIG. 5C as viewed from a location perpendicular to the axis of the fuselage in accordance with various embodiments;

FIG. 6A illustrates a front view of an exemplary camming mechanism coupled to a nose, rear retracting landing gear as viewed from the front of the aircraft configured for use with the spring system, in accordance with various embodiments;

FIG. 6B illustrates a profile view of the exemplary camming mechanism of FIG. 6A as viewed from a location perpendicular to the axis of the fuselage in accordance with various embodiments;

FIG. 6C illustrates a front view of an exemplary camming mechanism configured for use with the motive force system coupled to a nose, rear retracting landing gear as viewed from the front of the aircraft, in accordance with various embodiments;

FIG. 6D illustrates a profile view of the exemplary camming mechanism of FIG. 6C as viewed from a location perpendicular to the axis of the fuselage in accordance with various embodiments; and

FIG. 7 depicts a process flow of an exemplary spring assisted landing gear deployment system, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Reduction of the weight of an aircraft provides enhanced fuel efficiency, among other benefits. Achieving this goal in large aircraft (e.g., commercial aircraft) has been conventionally hindered with respect to the landing gear deployment system. Landing gear actuation typically requires large forces, especially towards the end of the retraction stroke of a landing gear column. The landing gear of large aircraft (e.g., commercial aircraft) is on the order of 2-6 tons (1814-5443 kilograms). This landing gear must be capable of dampening the effect of the entire weight of an aircraft traveling at ground speeds of over 200 mph (321.9 kilometers/hour) while landing. Thus, the landing gear should be robust. Reducing the weight of landing gear, without reducing the functionality the landing gear, is difficult. Thus, steps to reduce the weight of the landing gear assembly may focus on other aspects of the landing gear assembly rather than the landing gear itself.

The systems used to retract and deploy this generally very heavy landing gear should similarly be extremely robust and error resistant. Moreover, the force for moving the landing gear in a direction from an extended and deployed position (generally vertical orientation) to a retracted and stowed (generally horizontal orientation) position increases as the landing gear moves from the vertical position to the horizontal position. Moreover, the torque as measured at a pivot of the landing gear column increases as the landing gear moves from the fully deployed orientation to a stowed position. Historically, hydraulic systems have been used to retract and deploy landing gear systems. These hydraulic systems are complex and heavy. The present disclosure addresses these and other concerns.

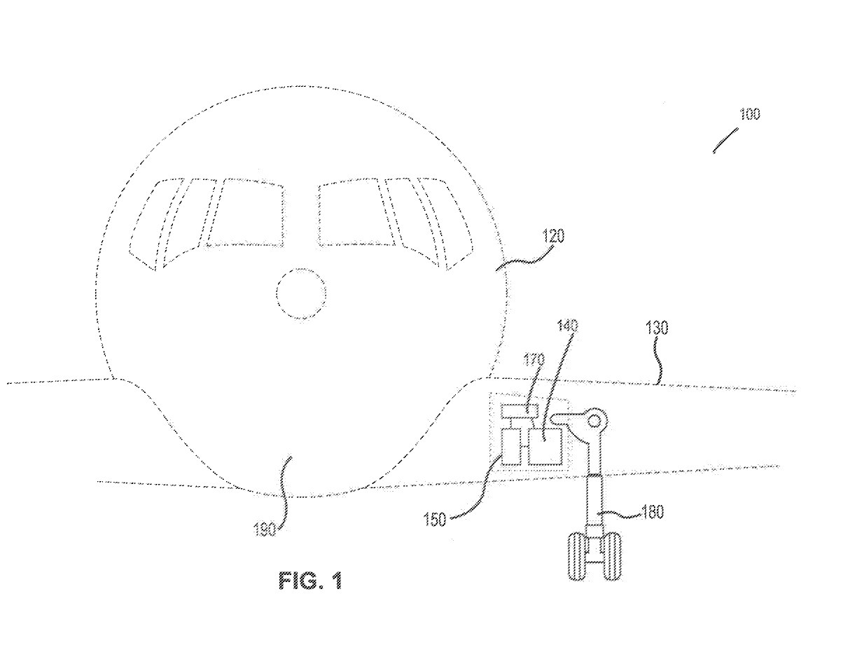

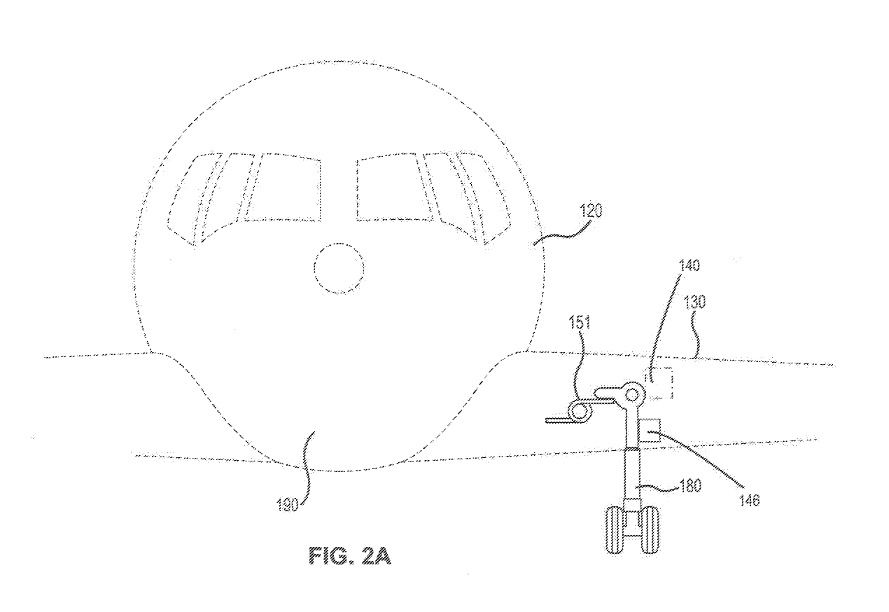

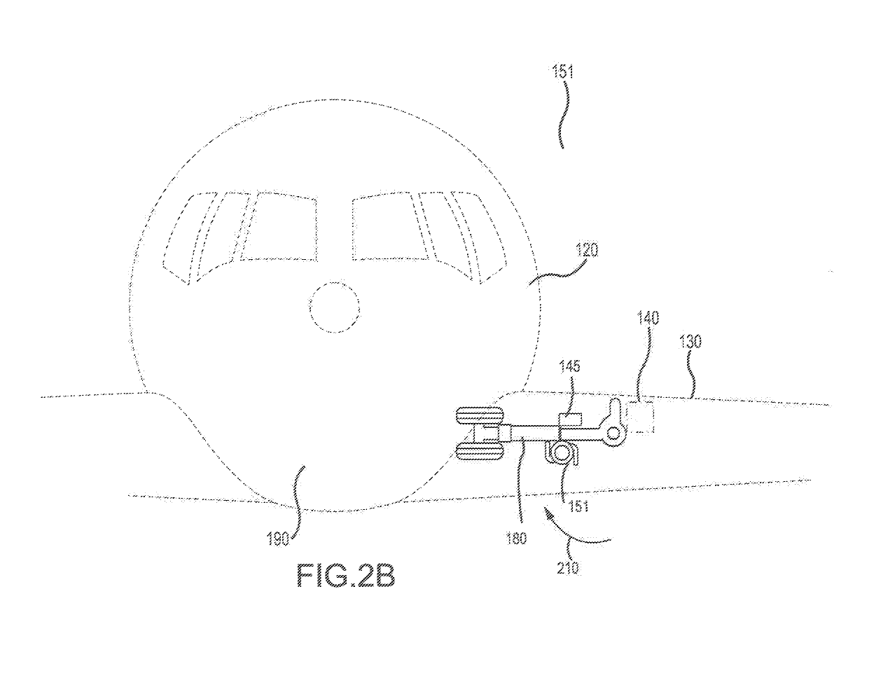

According to various embodiments and with reference to FIG. 1, systems and methods disclosed herein may be directed to a spring assisted landing gear 180 deployment system 100. As discussed herein, concepts applicable to landing gear deployment: such as deployment from a stowed position to a deployed, landing, take-off and/or taxi position, shall be understood to be generally applicable to extension of landing gear; and such as deployment from a retracted position from a landing, take-off and/or taxi position to a stowed position, shall be generally be understood to be generally applicable to retraction of the landing gear. Landing gear 180 and its deployment may take many forms on an aircraft. Landing gear 180 (sometimes referred to as the undercarriage in aviation) is the structure that supports an aircraft on the ground and allows it to taxi, takeoff and land. Typically, wheels are used, but skids, skis, floats or a combination of these and other elements can be used, depending on the landing surface. These landing gear assemblies may comprise any number of wheels, and be located anywhere on the aircraft. For instance, landing gear may be deployed from the nose 190, as illustrated in FIG. 2, of the aircraft, the fuselage 120 and/or the wings 130. Any of these landing gear assemblies may be deployed in any direction.

According to various embodiments, spring system 150 disclosed herein may provide a counterbalancing of the weight of a landing gear 180 assembly. Thus, spring system 150 may reduce the amount of force required to move landing gear 180 assembly by a motive force system 140. This movement may be in either the deploy or the retract direction of landing gear 180.

According to various embodiments, spring system 150 disclosed herein may be biased towards the retracted or deployed position. For instance, spring system 150 biased towards retraction may store energy as landing gear is moved from a stowed position to a deployed position. For example, in a gravity-aided deployment where a motive force system 140 may control the deployment of landing gear 180, spring system 150 may store energy as landing gear 180 is moved from a stowed position to a deployed position. Spring system 150 may translate its stored energy to assist the landing gear 180 being moved from the deployed position to the stowed position. Thus, the force provided by motive force system 140 to move landing gear 180 from the deployed position to the stowed position may be decreased, as compared with conventional landing gear actuation systems.

For instance, according to various embodiments, landing gear 180 may retract forward or aft facing, such as landing gear 180 retracting towards the tail of the aircraft. Also, landing gear may deploy inboard or outboard, such as is typical of landing gear 180 located near the wings. Of course, variations to these directions are contemplated herein. For example, landing gear 180 are known to rotate as part of their deployment. Also, concepts consistent with the present disclosure are applicable to landing gear 180 that moves in a linear direction.

According to various embodiments and with reference to FIG. 1, a motive force system 140 may be coupled to a portion of landing gear 180. This motive force system 140 may be located in any suitable position and/or orientation such that it is coupled to landing gear 180 and may move landing gear 180 from a stowed position to a deployed position and/or move landing gear 180 from a deployed position to a stowed position. The motive force system 140 may be a hydraulic system, such as one having a hydraulic piston, an electric system, such as one having an electromechanical actuator, a mechanical system, such as one having gears and/or a spring and/or a combination thereof. With renewed reference to FIG. 1, landing gear 180 is depicted in the vertical, deployed position.

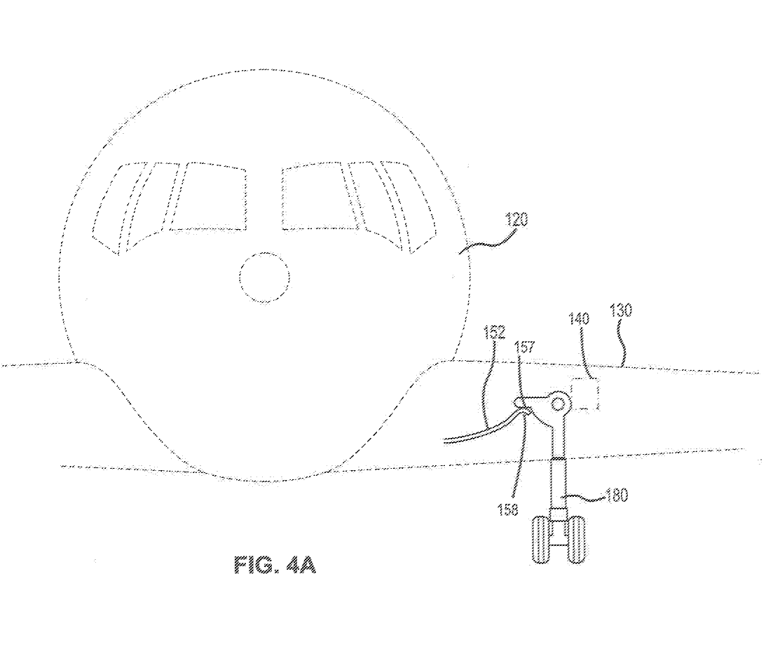

A spring system 150 may assist motive force system 140 in moving landing gear 180 from a stowed position to a deployed position and/or move landing gear 180 from a deployed position to a stowed position. For instance, spring system 150 may at least partially counterbalance the weight of landing gear 180 such that the force by motive force system 140 to move landing gear 180 may be at least partially offset. Spring system 150 may comprise any suitable spring for counterbalancing the weight of landing gear 180. The spring of spring system 150, such as torsion spring 151 and/or leaf spring 152 of FIGS. 2 and 4 respectively, may be an elastic object used to store mechanical energy (potential energy). The spring of spring system 150, such as torsion spring 151 and/or leaf spring 152, may comprise a low spring constant and a high deflection value, so as to minimize variation in force throughout the stroke. For example, spring system 150 may comprise a torsion spring 151, a leaf spring 152 and/or the like. Spring system 150 may be biased in either direction, such as biased to deploy the landing gear or biased to retract landing gear 180. According to various embodiments, the force provided by spring system 150 is configured to be and/or approach the maximum amount of force to support the weight of landing gear 180, without preventing a gravitational deployment of landing gear 180. The force provided by the spring of spring system 150 may be selected to provide a smooth counterbalanced rate of travel of deploying landing gear.

According to various embodiments, the force provided by spring system 150 and/or motive force system 140 is adequate to move landing gear 180 from a stowed position to a deployed and locked position. For instance, a locking mechanism 146 (e.g., a down piston gear lock) may automatically engage a landing gear 180 column, in response to landing gear 180 being in a desired location or traveling past a pre-selected location with a requisite amount of force.

According to various embodiments, the sizing of the force output of spring system 150 may be configured such that spring system 150 may balance the peak or average extension and retraction forces for motive force system 140. Motive force system 140 may have approximately the same force capability in both the extend and retract directions, (e.g. an electric actuator). For example, spring system 150 may be configured for use with a motive force system 140 with advance and peak retract forces that are approximately equal.

The sizing of the force output of spring system 150 may be configured such that spring system 150 biases the peak or average extension and retraction forces of landing gear 180 in the direction favored by an actuator which has unequal capability in the extend and retract directions, such as a hydraulic actuator. For example, spring system 150 may be compatible with a motive force system 140 with force asymmetry between advance or retract mode.

According to various embodiments, the sizing of the force output of spring system 150 may be configured such that spring system 150 permits landing gear 180 to fall free under its own weight and activate the down position gear lock. This may be activated in response to a loss of power to the primary actuation system, such as a loss of power to motive force system 140.

According to various embodiments, the spring force may be relieved by deactivating the spring, either temporarily or permanently. This deactivation may occur to permit the landing gear 180 to fall free under its own weight and activate a down position gear lock.

Spring system 150 may be configured to reduce the size, weight and/or energy requirements of a landing gear 180 extension/retraction system. For instance, in various embodiments, the size, weight and/or energy requirements of the motive force system 140 are less than a conventional landing gear extension/retraction system for a similar application. According to various embodiments, the spring of spring system 150, such as torsion spring 151 and/or leaf spring 152, may be made from any material. For instance, the spring of spring system 150 (e.g., torsion spring 151 and/or leaf spring 152) may be at least one of a ferrous material, a non-ferrous material, ferrous metal, non-ferrous metal, alloy, and a composite material consisting of high strength fibers or particles, such as glass, carbon fiber, graphite or other high-strength ceramic or intermetallic fiber or particulate in a polymer or metallic matrix. A reinforcing material for this composite material may consist of fibers which extend most or all the length of the composite structure or may be short relative to the dimensions of the structure. They may be oriented in the directions of the principal stresses experienced by the structure or may not be given a specific direction, as in the case of chopped fibers or particles.

According to various embodiments, torsion spring 151 may be comprised of any material. For instance, torsion spring 151 may be made from a composite material. Torsion spring 151 may have any suitable cross sectional geometry. According to various embodiments, torsion spring 151 comprises a rectangular, circular, oval, square or an I-beam cross-sectional geometry with sharp, rounded or beveled corners. According to various embodiments, torsion spring 151 may comprise a hollow cross section. This may reduce the weight of landing gear deployment system 100.

Torsion spring 151 may be configured to observe an angular form of Hooke's law: T=−Kθ. θ is the angle of twist from its equilibrium position in radians and T is the torque exerted by torsion spring 151 in newton-meters (Nm). K is a constant with units of newton-meters/radian. The torsion coefficient, torsion elastic modulus, rate or spring constant of torsion spring 151 is equal to the delta in torque to twist torsion spring 151 through an angle of 1 radian.

According to various embodiments, spring system 150 is coupled between an anchoring location and a portion of landing gear 180. This anchoring location may be any suitable anchoring location. According to various embodiments, spring system 150 is designed such that the point of failure occurs in the spring of spring system 150 rather than in an anchoring location. Moreover, spring system 150 is configured such that failure of spring system 150 does not prevent deployment of landing gear 180 and/or present a threat of damage to surrounding structures.

According to various embodiments and with reference to FIG. 1, the landing gear deployment system 100 may comprise a secondary fail-safe deployment system 170. Thus, the secondary fail-safe system 170 is configured to deploy landing gear 180 to an extended deployed position. Secondary fail-safe system 170 may be any fail safe system. For example, the secondary fail-safe system 170 may assist in a gravitational deployment of landing gear 180. Secondary fail-safe system 170 may comprise a gas deployed o time use device to provide additional force to deploy landing gear 180, such as to provide additional force to motive force system 140 and/or spring system 150. According to various embodiments, a chemical gas generator can provide rapid and high force to assist with and/or deploy landing gear 180. For example the secondary fail-safe system 170 may comprise a piston driven by expanding gasses, with a latch that overrides landing gear 180 locking mechanism. Though depicted and described with reference to the embodiment depicted in FIG. 1, secondary fail-safe system 170 may be utilized with any embodiment described herein, such as the embodiments depicted in FIGS. 2A-2B and 4A-4B.

With continued reference to FIG. 1, in response to an emergency condition, such as spring system 150 failure or a motive force system 140 failure, a secondary fail-safe system 170 deployment may be actuated. This may comprise unlocking the landing gear doors, firing the secondary fail-safe system 170, and forcing landing gear 180 to be deployed in a locked position.

According to various embodiments and with reference to FIG. 2A, as noted above, spring system 150 may comprise a torsion spring 151. Though torsion spring 151 may be located in any location, having any suitable orientation, according to various embodiments, the location of torsion spring 151 is such that the axis of torsion spring 151 is the same as the pivot axis of landing gear 180 column. It is also possible, though less compact, to locate torsion spring 151 off to one side of landing gear 180. An off-axis torsion spring 151 may be mounted inboard or outboard of the gear pivot. According to the embodiment depicted in FIG. 2A, landing gear 180 are oriented in a landing, take-off and/or taxi position.

Torsion spring 151 may be coupled to landing gear 180 such as by mounting a portion of torsion spring 151 to an anchor point offset from landing gear 180 column. Torsion spring 151 may impart a rotational force on the landing gear which counterbalances the weight of landing gear 180. This may reduce the load on motive force system 140, such as by reducing the load on an actuator as landing gear 180 extends or retracts. Thus, a smaller electric actuator may be utilized in the present system as compared to a landing gear system that does not employ spring system 150.

In FIG. 2B, components of like numbering with the components of FIGS. 1 and 2A are assembled as discussed above with reference to FIGS. 1-2A. According to various embodiments and with reference to FIG. 2B, landing gear 180 are depicted in a stowed position and held in place by locking mechanism 146. Movement of landing gear 180 from the landing, take-off and/or taxi position as depicted in FIG. 2A along path 210, may store energy in torsion spring 151 as depicted showing torsion spring 151 in an energy storing orientation.

According to various embodiments, spring system 150 may be coupled to a transfer mechanism such as a pinion, gear, lever or other transfer or transformation mechanism to exert a rotational force originating in a spring on landing gear 180 which counterbalances the weight of landing gear 180.

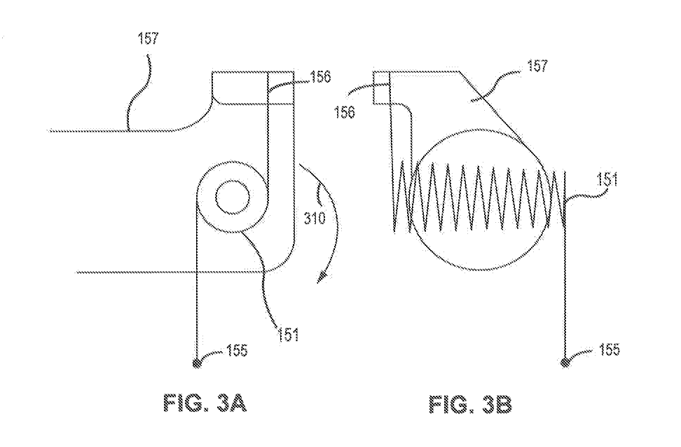

An exemplary transfer mechanism is depicted in FIGS. 3A and 3B. For instance, though it could be oriented in any direction, FIG. 3A depicts a profile view of a transfer mechanism 157 and a side view of torsion spring 151 coupled to transfer mechanism 157. Similarly, FIG. 3B depicts a side view of the transfer mechanism 157 of FIG. 3A and a profile view of torsion spring 151 coupled to transfer mechanism 157. A first distal end 155 of torsion spring 151 may be anchored at an anchoring location, such as a fixed location of an aircraft and a second distal end 156 of torsion spring 151 may be coupled to the transfer mechanism 157. Transfer mechanism 157 may be coupled to and/or integral to landing gear 180. Arrow 310 depicts movement of transfer mechanism 157 which is, in general, in concert with movement of landing gear 180 such as along path 210.

In FIGS. 4A and 4B, components of like numbering with the components of FIGS. 1, 2A and 2B are assembled as discussed above with reference to FIGS. 1-2B. With reference to FIG. 4A, as discussed above, spring system 150 may be located in any suitable location and be coupled to any suitable anchor point of landing gear 180 and the aircraft. Spring system 150 may comprise a leaf spring, such as leaf spring 152, which may be mounted inside the aircraft wing 130 and coupled to landing gear 180. This mounting may be inboard or outboard of the landing gear 180 pivot/axis of rotation location. Leaf spring 152 may be integrated as a stiffening member of the wing 130.

According to various embodiments, leaf spring 152 may be incorporated such that leaf spring 152 is configured to act as a stiffening member in the wing box, and/or is incorporated as a part of the wing box. For example, as used herein, the wing box of an aircraft may be the structural component from which the wings extend. It is usually limited to the section of the fuselage between the wing roots, although on some aircraft designs the wing box of the aircraft may be considered to extend further distally as measured from the fuselage. According to various embodiment, spring system 150 may comprise a single leaf spring 152 coupled to each landing gear 180. A portion of leaf spring 152 may be fixed to a portion of the aircraft at a mounting location.

With continued reference to FIG. 4A, a distal end 158 of leaf spring 152 may be coupled to a pivot, transfer mechanism (such as transfer mechanism 157 depicted in FIGS. 3A and 3B) and/or a portion of landing gear 180 column. Landing gear 180 column may be coupled between a wheel and the body of the aircraft. Leaf spring 152 may be configured to impart a force on a portion of landing gear 180. The force may be biased in the retract or the deployed position. Similar to locking mechanism 145 depicted in FIG. 2B, Landing gear 180 may be held in a first position, such as a stowed position, by a locking mechanism 146. In response to the locking mechanism being released, leaf spring 152 may transfer its stored energy to assist with moving landing gear 180 on its path of travel to a second position, such as a deployed position, as depicted in FIG. 4A. Motive force system 140 may operate in concert with leaf spring 152 to move landing gear 180 from the first position to the second position. Operation of motive force system 140 may be initiated prior to the initiation of operation of spring system 150, be initiated in concert with the initiation of operation spring system 150 or be initiated after the initiation of spring system 150. The operation of spring system 150 and motive force system 140 may be harmonized and optimized to produce a smooth steady rate of travel. For instance, spring system 150 and motive force system 140 may be governed to match the force capabilities of the motive force system 140 and/or spring system 150 respectively.

Leaf spring 152 may be oriented in any position. For instance, leaf spring 152 may push up or down to lift landing gear 180. With continued reference to FIG. 4A, leaf spring 152 is depicted as pushing up the landing gear 180 and/or pushing up on transfer mechanism 157. A fuselage 120 mounted leaf spring 152 may be oriented up (over) or down (under) with respect to the side of the pressure vessel. FIG. 4A depicts leaf spring 152 oriented under the pressure vessel interior to the fuselage 120.

Leaf spring 152 may be oriented in any position. For instance, leaf spring 152 may push up or down to lift landing gear 180. With continued reference to FIG. 4A, leaf spring 152 is depicted as pushing up the landing gear 180 and/or pushing up on transfer mechanism 157. Fuselage 120 mounted leaf spring 152 may be oriented up (over) or down (under) with respect to the side of the pressure vessel. FIG. 4A depicts leaf spring 152 oriented under the pressure vessel interior to the fuselage 120.

According to various embodiments and with reference to FIG. 4B, spring system 150 comprising leaf spring 153 may be coupled to a pair of landing gear 180, such as a plurality of landing gear 180 located near the wings of the aircraft. For instance, FIG. 4B represents a full through-pressure-vessel mount of spring system 150, where one spring, such as leaf spring 153, counterbalances a set of two landing gear 180 on either side of the fuselage 120 and may be incorporated into the cargo hold floor, bulkhead and/or other structural member. Leaf spring 153, may be generally centered, spanning a width of the aircraft oriented generally perpendicular to the fuselage 120 of the aircraft. The center of leaf spring 153 may be generally fixed in substantially the center of the aircraft. According to various embodiments, spring system 150 comprising leaf spring 153 may be configured for a full around-pressure-vessel mount, where the same spring, such as leaf spring 153, counterbalances a plurality of landing gear 180. According to various embodiments, such as one where leaf spring 153 counterbalances a plurality of landing gear 180, the operation of spring system 150 and/or motive force system 140 may be configured or commanded to disallow the retraction of all associated landing gear 180 in response to the retraction of a single landing gear 180 failing. As noted above, spring system 150 may be incorporated into the fuselage 120/wing box.

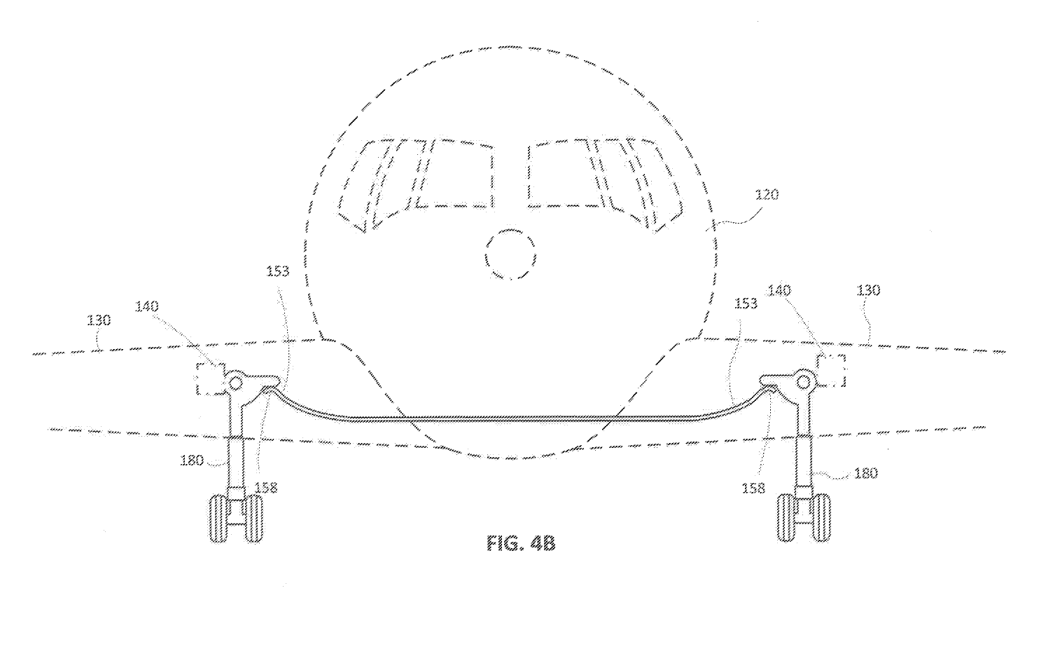

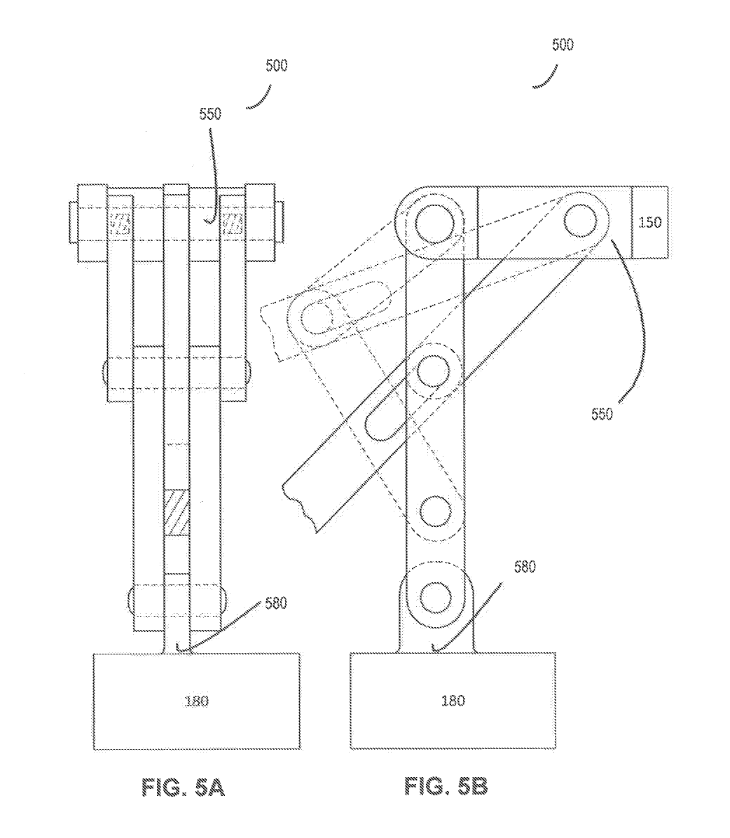

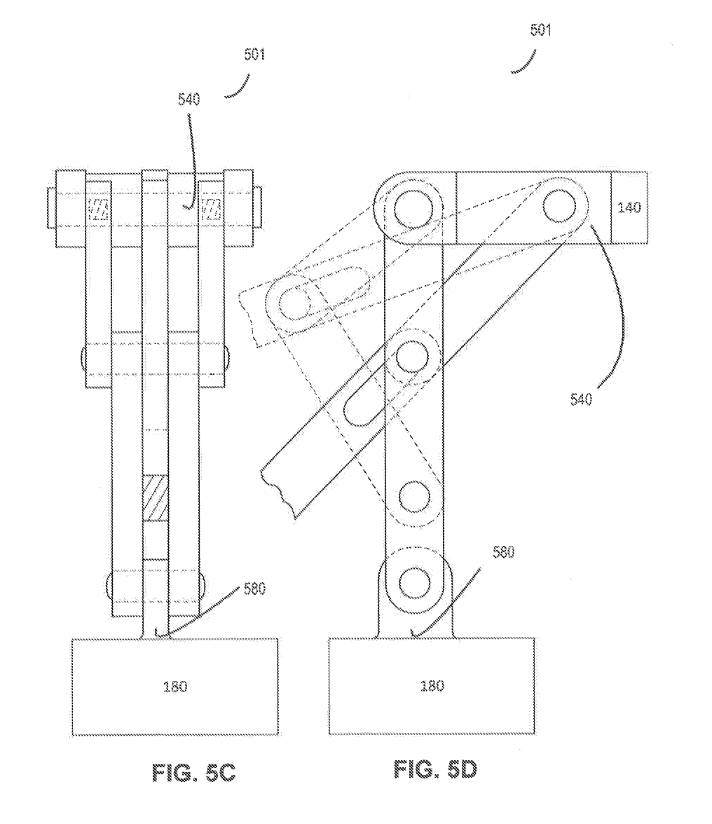

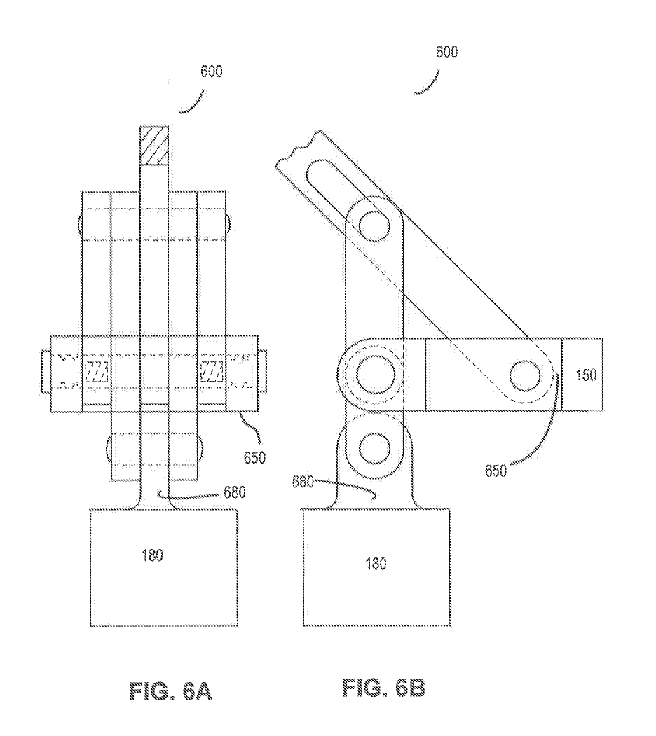

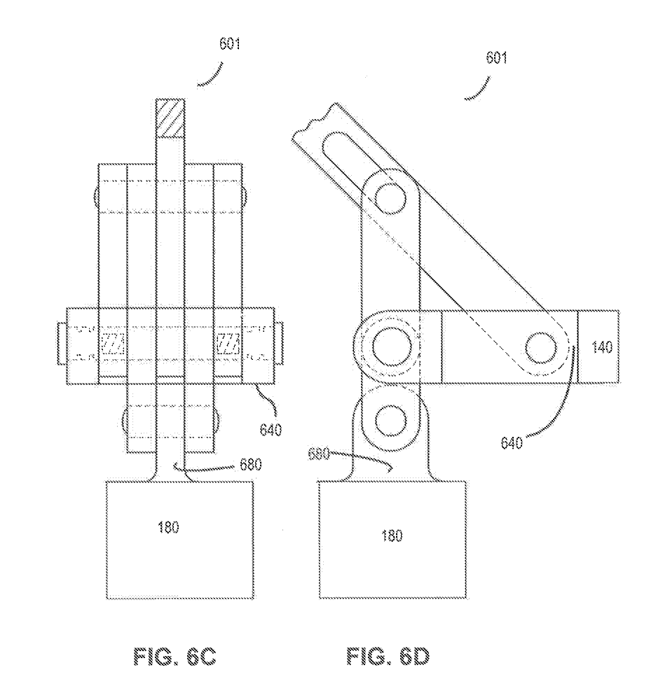

According to various embodiments and with reference to FIGS. 5A-5D, landing gear 180 deployment system 100 may include a camming mechanism 500, 501 which creates varying mechanical advantages throughout its stroke. FIG. 5A illustrates a front view of an exemplary camming mechanism configured for use with the spring system, in accordance with various embodiments. For instance, though landing gear 180 may be oriented to retract and deploy forward, aft facing, inboard or outboard, to ease with description FIGS. 5A and 6A depict a front view of a camming mechanism as viewed from the front of the aircraft coupled to a nose positioned landing gear 180 configured to retract towards the tail of the aircraft. FIG. 5B illustrates a profile view of the exemplary camming mechanism of FIG. 5A, for instance, as viewed from the side of the aircraft perpendicular to the axis of fuselage 120. FIG. 6B illustrates a profile view of the exemplary camming mechanism of FIG. 6A, for instance, as viewed from the side of the aircraft perpendicular to the axis of fuselage 120. FIGS. 5C and 6C depict a front view of a camming mechanism as viewed from the front of the aircraft coupled to a motive force system 140 coupled to a nose positioned landing gear 180 configured to retract towards the tail of the aircraft. FIG. 5D illustrates a profile view of the exemplary camming mechanism of FIG. 5C, for instance, as viewed from the side of the aircraft perpendicular to the axis of fuselage 120. FIG. 6D illustrates a profile view of the exemplary camming mechanism of FIG. 6C, for instance, as viewed from the side of the aircraft perpendicular to the axis of fuselage 120.

The force on a spring of spring system 150 (e.g., the force on torsion spring 151 and/or leaf spring 152, 153 as depicted in FIGS. 2A-2B and 4A-4B respectively) varies with the magnitude of deflection. Conversely, most actuators are designed to have linear force capability throughout their path of travel. These forces can be harmonized by the use of a cam (camming mechanism 500, 501, 600, 601) or differential motion pivot to modify the mechanical advantage of torsion spring 151 and/or leaf spring 152, 153 during deployment and/or retraction (hereafter referred to as “cam”).

Spring system 150 and/or motive force system 140 may be configured to be cammed via camming mechanism 500, 501, 600, and/or 601 to decrease and/or increase the force imparting characteristics of spring system 150 within certain ranges of travel. Stated another way, camming mechanism 500, 501, 600, and/or 601 may reorient the direction of and/or location of force application by at least one of motive force system 140, spring system 150 to landing gear 180.

With reference to FIGS. 5A-5B at or near part 580, camming mechanism 500 may be coupled to landing gear 180. At or near part 550, camming mechanism 500 may be coupled to a portion of spring system 150.

With continued reference to FIGS. 5A-5B, camming mechanism 500 may be configured to offset the forces applied to the ends of spring system 150. Stated another way, landing gear 180 deployment system 100 may further comprise a camming mechanism 500 to distribute the direction and/or location of forces applied to landing gear 180. For instance, camming mechanism 500 may be interposed between spring system 150 and landing gear 180. Camming mechanism 500 may redirect the force and or orientation of spring system 150 in any suitable direction. For example, the last few degrees of retraction of landing gear 180 are typically associated with the greatest forces, since gravity is acting perpendicular to landing gear 180 strut/column. Substantially simultaneously the spring of spring system 150 (e.g., torsion spring 151) is near the end of its travel. Thus, the stored force of the spring of spring system 150, such as torsion spring 151, is less as compared with other points of landing gear 180 travel. Similarly, gravity has little effect as landing gear 180 is near its fully-deployed position, since landing gear 180 is acting parallel to its lever arm (e.g. in the substantially vertical direction, thus effecting little or no torque). In this position, the substantially vertical direction, according to various embodiments, spring resistance may be at a maximum, since this is the greatest extent of travel of landing gear 180. Thus, camming mechanism 500 may be configured to apply and orient spring force and/or modify spring mechanical advantage near and/or at the filly-deployed position of landing gear 180. Camming mechanism 500 may facilitate transfer of force such that landing gear 180 locks in a deployed position with minimal effort. Similarly, camming mechanism 500 may facilitate transfer of force such that landing gear 180 locks in a stowed position with minimal effort.

With reference to FIGS. 6A-6B, components of like numbering with the components of FIGS. 5A-5B are assembled as discussed above with reference to FIGS. 5A-5B. Camming mechanism 600 operates similar to camming mechanism 500. For instance, aspects described herein relevant to part 550 are applicable to part 650. Similarly, aspects described herein relevant to part 580 are applicable to part 680.

With reference to FIGS. 5C-5D at or near part 540 camming mechanism 501 may be coupled to a portion of motive force system 140. Camming mechanism 501 may be configured to offset the forces applied to the ends of motive force system 140. Stated another way, landing gear 180 deployment system 100 may further comprise a camming mechanism 501 to distribute the direction and/or location of forces applied to landing gear 180. For instance, camming mechanism 501 may be interposed between motive force system 140 and landing gear 180. Camming mechanism 501 may redirect the force of motive force system 150 in any suitable direction. Similar to camming mechanism 500 described above, camming mechanism 501 may be configured to modify motive force system 140 force near and/or at the fully-deployed position of landing gear 180. Camming mechanism 501 may facilitate transfer of force such that landing gear 180 locks in a deployed position with minimal effort. Similarly, camming mechanism 501 may facilitate transfer of force such that landing gear 180 locks in a stowed position with minimal effort.

With reference to FIGS. 6C-6D, components of like numbering with the components of FIGS. 5C-5D are assembled as discussed above with reference to FIGS. 5C-5D. Camming mechanism 601 operates similar to camming mechanism 501. For instance, aspects described herein relevant to part 540 are applicable to part 640. Similarly, aspects described herein relevant to part 580 are applicable to part 680.

Of course, the embodiments depicted in FIGS. 5A-6D are exemplary and not intended to restrict the operation and/or geometry of camming mechanism 500, 501, 600, and/or 601. Camming mechanisms 500, 501, 600, and/or 601 may be configured to modify the direction and orientation of the force of both motive force system 140 and spring system 150, such as simultaneously modifying the mechanical advantage of both motive force system 140 and spring system 150. According to various embodiments, camming mechanism 500, 501, 600, and/or 601 may be integrated with the up position landing gear 180 locking mechanism 145. According to various embodiments, camming mechanism 500, 501, 600, and/or 601 may be integrated with the down position landing gear 180 locking mechanism 146.

Aspects of spring assisted landing gear 180 deployment system 100 may be in communication with a controller, such as via a receiver. This controller may be configured to initiate operation of various systems. For instance, the controller may be electronically coupled to motive force system 140, spring system 150 and/or landing gear 180. Controller may be configured to send signals, such as non-transitory signals, to initiate functionality. Controller may be coupled to a memory, which may be any kind of memory.

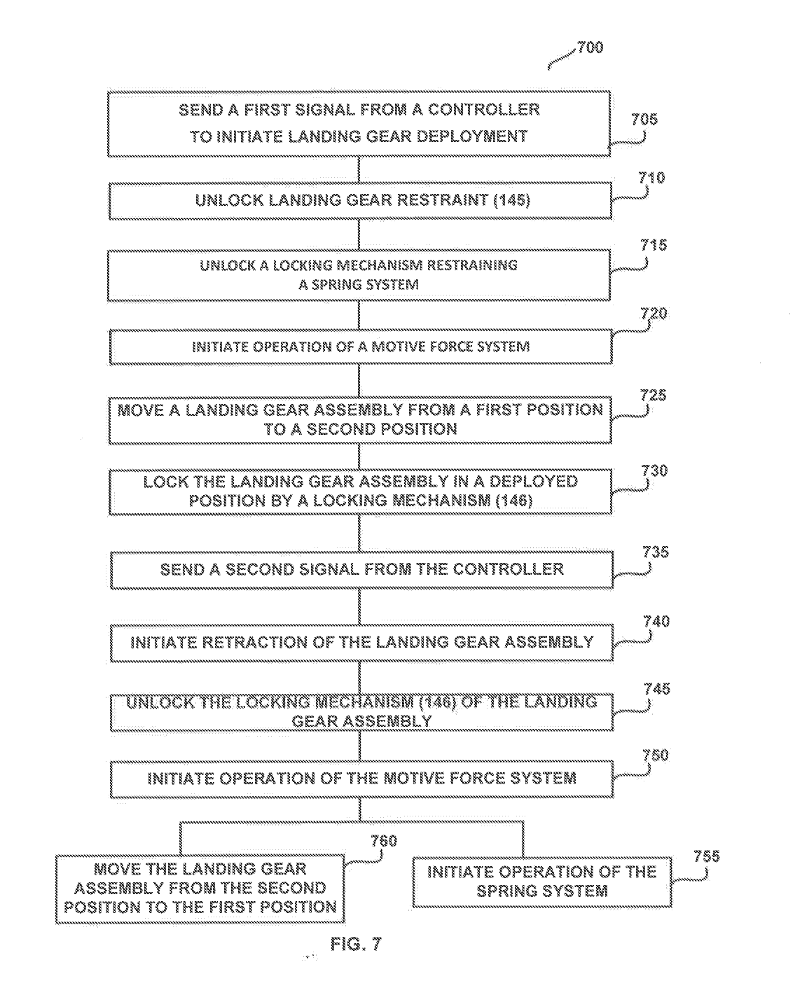

According to various embodiments and with reference to FIG. 7 and process flow 700, a controller may send a signal to a locking mechanism 145 retaining landing gear 180 in its stowed position (Step 705). This signal may unlock locking mechanism 145 (Step 710). Locking mechanism 145 may be restraining movement of landing gear 180 and/or operation of motive force system 140 and/or spring system 150 (Step 715). A second restraint may restrain operation of motive force system 140 and/or spring system 150. The motive force system 140 may impart a force on a portion of landing gear 180 (Step 720). Counterbalanced spring system 150 may store energy as it moves in concert with landing gear 180. Gravity may assist movement of landing gear 180. Landing gear may move from a stowed position to a deployed and locked position (Step 725). Landing gear 180 may automatically lock into a locked position, such as via a locking mechanism 146 (Step 730).

According to various embodiments and with continued reference to FIG. 7, the controller may send a signal to a locking mechanism 146 retaining landing gear 180 in its deployed position (Step 735). The signal may initiate retraction of landing gear 180 (Step 740). This signal may unlock locking mechanism 146 (Step 745). The motive force system 140 may impart a force on a portion of landing gear 180 (Step 750). Counterbalanced spring system 150 may assist the movement of the landing gear 180 relative to the aircraft (Step 755). This assistance may be automatic or it may be in response to locking mechanism and/or restraint restricting the operation of spring system 150 being removed. Landing gear may move from a deployed position to a stowed and locked position (Step 760). Landing gear may be retained in the locked position by locking mechanism 145. Locking mechanism 145 and locking mechanism 146 may be the same or different locking mechanism.

As used herein, the phrases “make contact with,” “coupled to,” “touch,” “interface with” and “engage” may be used interchangeably. Different cross-hatching may be used throughout the figures to denote different parts but not necessarily to denote the same or different materials.

In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. As used herein, the term adjacent may mean in close proximity to, but does not necessarily require contact. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An aircraft landing gear deployment system comprising:
a landing gear assembly movable from a first position to a second position;
a motive force system coupled to the landing gear assembly and comprising at least one of a hydraulic piston or an electromechanical actuator;
a spring system configured to assist the motive force system in translating the landing gear assembly from the first position to the second position, wherein the spring system comprises at least one of a leaf spring or a torsion spring; and
a transfer mechanism coupled to the spring system and configured to move in concert with the landing gear assembly.

2. The aircraft landing gear deployment system of claim 1, further comprising a camming mechanism coupled between the motive force system and the landing gear assembly, wherein the camming mechanism provides a mechanical advantage to the motive force system.

3. The aircraft landing gear deployment system of claim 1, further comprising a fail-safe secondary landing gear assembly deployment system.

4. The aircraft landing gear deployment system of claim 3, wherein the fail-safe secondary landing gear assembly deployment system comprises a piston driven by expanding gas.

5. The aircraft landing gear deployment system of claim 1, wherein a single spring system is configured to counterbalance a plurality of landing gear assemblies.

6. The aircraft landing gear deployment system of claim 1, wherein a force provided by the spring system is configured to be less than a maximum amount of force required to support a weight of the landing gear assembly and insufficient to prevent a gravitational deployment of the landing gear assembly.

7. The aircraft landing gear deployment system of claim 1, wherein the spring system is biased towards deployment.

8. The aircraft landing gear deployment system of claim 1, wherein the spring system comprises least one of a ferrous material, a non-ferrous material, ferrous metal, non-ferrous metal, alloy, composite material, such as glass, carbon fiber, graphite, ceramic, intermetallic fiber, particulate, metal, or polymer matrix.

9. The aircraft landing gear deployment system of claim 1, wherein the spring system comprises a geometry that is at least one of a rectangle, I-beam, circular, oval, hollow and a square cross-section and with at least one of sharp, rounded and beveled corners.

10. The aircraft landing gear deployment system of claim 1, wherein the spring system is a stiffening member of at least one of a wing and a wing box.

11. A method of deploying landing gear from a stowed position to a landing position comprising:
receiving a first signal from a controller to initiate landing gear retraction;
initiating operation of a motive force system configured to move a landing gear assembly from a first position to a second position;
unlocking a locking mechanism restraining a spring system, wherein the spring system is configured to counterbalance a weight of the landing gear assembly; and
locking the landing gear assembly in a deployed position.

12. The method of claim 11, further comprising:
receiving a second signal from the controller to initiate deployment of the landing gear assembly;
unlocking the landing gear assembly;
initiating operation of the motive force system configured to move the landing gear assembly from the second position to the first position; and
storing energy in the spring system by moving the landing gear assembly from the second position to the first position.

13. The method of claim 11, further comprising modifying a mechanical advantage of the motive force system by a camming mechanism coupled between the motive force system and the landing gear assembly.

14. The method of claim 11, wherein the spring system comprises at least one of a leaf spring and a torsion spring.

15. The method of claim 11, wherein the motive force system comprises at least one of a hydraulic piston and an electric actuator.

16. An aircraft landing gear deployment system comprising:
a landing gear assembly;
a motive force system configured to move the landing gear assembly from a deployed position to a stowed position; and
a spring system configured to assist the motive force system in translating the landing gear assembly from the deployed position to the stowed position.
